(19) United States
(12) Patent Application Publication
(10) Pub. No.: US 2011/0045267 A1
(43) Pub. Date: Feb. 24, 2011

(54) Substructure material for a printing device and printer's blanket for the printing of uneven materials to be printed

(75) Inventors: Horst Appel, Hamburg (DE); Thomas Walther, St. Gallen (CH)

Correspondence Address: LUCAS & MERCANTI, LLP, 475 PARK AVENUE SOUTH, 15TH FLOOR, NEW YORK, NY, 10016, US

(73) Assignee: Hatec Produktions- und Handels- gesellschaft mbH

(21) Appl. No.: 12/800,186

(22) Filed: May 11, 2010

Related U.S. Application Data
(63) Continuation-in-part of application No. 10/110,336, filed on Jul. 8, 2002, now abandoned.

(30) Foreign Application Priority Data
Oct. 13, 1999 (DE) 299 18 060.3
Apr. 25, 2000 (DE) 100 20 209.8
Aug. 17, 2000 (DE) 200 14 158.9

(51) Int. Cl. B32B 3/26

(52) U.S. Cl. 428/220; 428/315.9

(57) ABSTRACT

In order to create a substructure material (100; 100′)
for a printing form, in particular a flatbedform or a printing plate (11), in particular a flatbed printing plate, and/or
for a printer's blanket (13), in particular a rubber blanket, specially a compressible or an incompressible rubber blanket, and/or
for another surface taking part in the printing process during the printing, in particular during the offset printing, by means of which there results an improved image to be printed and which makes possible the changing of printing forms or printing plates in an easier and quicker way, it is proposed that the substructure material (100; 100′) is configured as a replaceable compound (16, 17, 18; 16′, 17′), elastically deformable radially to the cylinder (10, 12, 15) assigned to the printing form or printing plate (11) and for to the printer's blanket (13; 70) and/or to the other surface participating to the printing process or radially to the assigned drum.

This application is a continuation-in-part application of U.S. patent application Ser. No. 10/110,336, filed on Jul. 8, 2002, which is the US National Phase of International Application No. PCT/EP00/010052, filed Oct. 12, 2000, which claims the priority of German Application No. 299 18 060.0, filed Oct. 13, 1999; German Patent Application No. 100 20 209.8 filed Apr. 25, 2000, and German Patent Application No. 200 14 158.9 filed Aug. 17, 2000.

### FIELD OF APPLICATION

The invention relates to a substructure material for a printing form, in particular a flatbed form or a printing plate, in particular a flatbed printing plate, and/or for a printer's blanket, in particular a rubber blanket, specially a compressible or an incompressible rubber blanket, and/or for another surface taking part in the printing process during the printing, in particular during the offset printing, as well as a printing device containing this substructure material, in particular an offset printing device and a printer's blanket for the printing of uneven materials to be printed, corrugated cardboard.

### PRIOR ART

In the printing technique, it is known to provide intermediate elements in printing groups which can compensate surface inequalities on a material to be printed during the transfer of an image to be printed. In all conventional printing processes, an image to be printed is applied inside the printing group by rolling off of cylinders or drums which transfer the image to be printed and guide the material to be printed onto a material to be printed. The image to be printed is thus produced on a printing form or a printing plate and can eventually be transmitted over a transfer cylinder to the material to be printed.

In a direct printing process such as the letterpress printing, for example for the flexographic printing, a printing form or a printing plate provided with elevated printing surfaces is used by means of which the image to be printed can be applied directly onto the material to be printed. For the offset printing, an indirect printing process, it is the question of a widespread flatbed printing process in which the image to be printed in form of the colour material is transferred by a printing form or printing plate to a transfer cylinder which is designated as a printer's blanket cylinder. The surface of the printing form or of the printing plate is provided in this connection with lipophil areas, i.e. water-repellent areas, according to the image to be printed so that the lipophil colour applied by an inking unit adheres thereto. The image to be printed is then transferred to the material to be printed by a printer's blanket cylinder, i.e. more precisely by a printer's blanket tentered onto the printer's blanket cylinder which is explained below.

For the offset printing, an indirect printing process, the image to be printed is transferred by a printing form onto a transfer cylinder which is designated as a printer's blanket cylinder. The image to be printed is then transferred onto the material to be printed by this cylinder. Normally a flexible layer is applied on the printer's blanket cylinder. In the normal offset printing process, a so-called printer's blanket or a rubber blanket is used for this. This printer's blanket is dimensionally stable in its extension plane but is deformable transversely to this plane. It can also be compressible in some extent in direction of its thickness. To this, it is known that compressible layers are provided inside a printer's blanket.

A flexible layer is usually applied on the printer's blanket cylinder; in the normal offset printing process, a so-called printer's blanket or rubber blanket is used here which is substantially dimensionally stable in its extension plane but which is deformable transversely to this plane. The printer's blanket can also be compressible in some extent in direction of its thickness. To this, it is known that compressible layers are provided inside the printer's blanket. The image to be printed is now deposited by this printer's blanket in form of the colour material onto the material to be printed, i.e. for example onto the paper to be printed or onto the cardboard to be printed.

Rubber blankets or the printer's blankets which are used for the offset printing technique are required in the offset printing process for the transfer of the image to be printed in particular also for compensating surface inequalities of the material to be printed. Since the printing forms or the printing plates for the offset printing are usually made of thin sheet steel or foils, they cannot adapt themselves sufficiently to the surface structure of the material to be printed.

For an adaptation to the surface structure of the material to be printed which is necessary for a sufficient printing quality, a printer's blanket must be pressed by the printer's blanket cylinder against the counter-pressure cylinder with a relatively high pressure force; this cannot be avoided by using so-called compressible printer's blankets because these printer's blankets have only a higher deformability than normal printer's blankets, require bower a comparatively high pressure force as well.

For the printing of uneven materials to be printed, limits are thus set to the conventional offset printing; on the one hand, A printer's blanket is only of limited deformability, whereby a sufficient pressing of the printers blanket to the material to be printed is required for maintaining an acceptable printing quality, on the other hand the material to be printed is limited in its stability under load.

So, there arises, for example for the printing of corrugated cardboard, a special problem which is connected with the inner structure of corrugated cardboard. Since in corrugated cardboard a corrugated connecting layer is provided between two covering layers for reducing the weight, a corrugated cardboard does not constitute a homogeneous material. The covering layers used on the upper and lower side of such a corrugated cardboard are only at certain points or are formed as lines and, in addition to this, are connected with each other by means of a corrugated intermediate layer by being offset to each other on both sides. When loading a corrugated cardboard, there result consequently non-uniform conditions over the surface; in particular, every covering layer is flexible in the areas between the connecting points with the corrugated intermediate layer and can thus yield when loaded in these areas. During the load in a printing process, there result consequently relatively unfavourable conditions for an uniform printing.

Thus, it has been known in the flexographic printing to fix a flexible and compressible underlay under the printing form or the printing plate. Here, the start is from the fact that the printing form or the printing plate itself is not compressible, i.e. that it is rigid and that the underlay makes possible a movement of the printing form or of the printing plate with respect to the form cylinder (=to the printing form cylinder or to the printing plate cylinder). A foam layer is for example provided as an underlay, this foam layer being applied on a tension loadable underlay. By means of the tension loadable underlay, the flexible underlay can thus be tentered simultaneously with the printing form on the printing form cylinder or with the printing plate on the printing plate cylinder, whereby a longitudinal extension is not to be expected.

In this way, the printing form or the printing plate is able to follow uneven spots on the surface of the material to be printed in some extent. Here, a deterioration of the printing quality must however be put up with, whereby this deterioration results inevitably from the deformation of the printing form or of the printing plate; this also depends on the usually very inhomogeneous distribution of printing and non printing areas on a printing form or on a printing plate; moreover, the registering of the printing forms or of the printing plates for the different printing colours is very difficult.

For the offset printing, such a method has not been known. It is known indeed to tenter so-called patching up sheets under the printer's blanket on the printer's blanket cylinder. These patching up sheets serve however only to the so-called making ready, whereby the circumference of the printer's blanket cylinder covered with the printer's blanket should be adjusted to the conditions required in a printing process.

Furthermore, only from the use of so-called compressible printer's blankets a method comparable with the above mentioned method of underlaying a printing form or a printing plate is used. The compressible printer's blanket makes deformations possible by thickness reduction only under a comparatively high pressure. The deformations necessary for the adaptation to the surface structure of the corrugated cardboard in such printer's blankets would automatically result in the destruction of the corrugated cardboard during the printing process before the printer's blanket could be sufficiently deformed. For this reason, there is no method known by means of which in the offset printing a highly uniform distribution of pressure is possible for the processing of a corrugated cardboard in a printing process.

The disadvantages and inadequacies outlined above as examples can be generalized in so far as the rotary cylinders which participate in the printing action of the offset process are generally made of a hard material, such as for example of metal. The printing form or the printing plate is also made of solid material such as for example of metal, such as aluminium, zinc or the like, or of plastics. Because of the dimensional stability of these materials, it can come to inequalities and unbalanced masses which influence negatively the image to be printed. Furthermore, the rigidity of said materials results in that the change of a printing form or of a printing plate can be difficult in so far as there is no resilience for the compensation of tolerances.

### AIM, SOLUTION, ADVANTAGE

Starting from here, the aim of this invention is to improve an offset printing machine of the type described in the introduction in such a way that there results an improved image to be printed, that the change of printing plates is possible in a quicker and easier way and that a printing of high quality images to be printed on uneven materials to be printed, in particular on a corrugated cardboard, is possible. Consequently, the aim of this invention is a high quality and uniform production of images to be printed over the surface on the material to be printed, for example on a paper web or on a corrugated cardboard in the offset printing technique; here, the material to be printed, for example the paper web or the corrugated cardboard, should not be mechanically damaged in any manner.

This aim is achieved by a substructure material with the characteristics indicated in claim 1 as well as by a printing device, in particular by an offset printing device, with the characteristics indicated in claim 13 and with a printer's blanket with the characteristics of claim 15.

Advantageous configurations and appropriate improvements of this invention are characterized in the respective subclaims.

The instruction of this invention provides a substructure material for a printing form, in particular a flatbed form or a printing plate, in particular a flatbed printing plate, and/or for a printer's blanket, in particular a rubber blanket, specially a compressible or an incompressible rubber blanket, and/or for another surface taking part in the printing process. Since the substructure material is formed as a replaceable compound, elastically deformable radially to the respective rotary cylinder or radially to the respective drum, inadequacies, dimensional tolerances and unbalanced masses of the components participating in the printing process can be compensated. A homogenizing and thus an improvement of the image to be printed can be achieved in this way.

Additionally to the increase of the printing quality, surprisingly a facilitation of the further equipment of an offset printing device is achieved by means of the substructure material according to this invention which can be configured in a compound as an underlay which can be tentered, in particular as a printing form underlay or a printing plate underlay which can be tentered and/or as a printers blanket underlay which can be tentered. By the assembly of the printing forms or printing plates on form cylinders, the substructure material because of its (radial) resiliency provides for the fact that eventual dimensional tolerances between the printing form or the printing plate and the form cylinder can be compensated. Consequently, by using higher forces and a corresponding yielding of the substructure material, the printing form or the printing plate can be fixed with a tight fit on the form cylinder.

With respect to the printers blanket cylinder, the skilled in the art in the filed of the printing technique will appreciate as an example that an increased deformation of the printers blanket radially to the printers blanket cylinder is made possible by the flexible substructure material under the printer's blanket during the printing process. The deformation is possible with a force which is lower with respect to the deformation of a compressible printer's blanket.

Simultaneously, the longitudinal stability of the printers blanket is maintained so that a good printing quality is guaranteed and the printing on an uneven surface such as, for example, on corrugated cardboard, is made possible in the offset printing technique.

In this context, there result further process advantages which come from the offset printing methods; in particular, they are the possibility of using cheap printing forms or printing plates as well as a easier registering for the multicolour printing.

According to a particularly inventive improvement of this substructure material, the compound is made of at least one compressible layer and of at least one incompressible layer.

Inadequacies, dimensional tolerances and unbalanced masses of the components taking part in the printing action are compensated by means of the compressible layer which can be preferably configured as a reversible compressible functional layer. A homogenizing and thus an improvement of the image to be printed can be achieved in this way.

Due to the connection of the compressible layer with an incompressible layer, it is simultaneously guaranteed that the substructure material can be advantageously manipulated so that the substructure material can be fixed on a cylinder participating in the printing process in particular with a sufficient stability. Furthermore, the connection of the compressible layer with an incompressible layer gives an increased stability to the compound material as a whole so that forces introduced into the compressible layer can cause only a limited deformation of the substructure material.

The compressible layers comprise a first compressible layer in direct contact with the printing form or printing plate, and a second compressible layer remote from the printing form or printing plate wherein the first compressible layer is thicker or stronger than the second compressible layer. The behavior of the substructure material during the introduction of pressure can be controlled by the combination of several compressible layers. As stated above, in special configuration of the substructure material, the substructure material contains at least two compressible layers, whereby these layers can preferably have a different structure with respect to the basis material and/or with respect to the structure (porosity) and/or a different thickness. The behaviour of the substructure material can be controlled by the combination of several compressible layers when pressure is introduced. Thus, a good local absorption of pressure and force peaks can be achieved for example by a thicker or a stronger compressible layer in direct contact with the printing form or printing plate, whereas a firmer (thinner) material in a lower position results in that bigger forces which are introduced are distributed over a bigger area. Such a substructure is not taught by the combinations of references relied upon by the Examiner.

According to a preferred embodiment of this invention, the compressible layer of the substructure material can be a microcellular material, preferably with open pores. A foam-type cell structure allows to adjust the compressibility of the material to some extent on request; if the microcellular compressible layer is appropriately formed of polyurethane foam, there results a high resistance with the desired compressibility. The basis material can be optimally selected with respect to other properties than the compressibility. for example with respect to its resistance to tearing and/or its resistance to chemicals.

The compression behaviour of the whole material is namely produced by its cellular structure which can be adjusted by the user to some extent at will depending on the respective requirements and independently of the basis material.

For the incompressible layer which is configured, according to an inventive improvement, as a dimensionally stable carrier layer, in particular as a dimensionally stable plate or foil, it can be the matter advantageously totally or partially of at least one synthetic material, preferably of polyester. Such a material is cost-effective, has a high resistance and is simultaneously flexible with respect to bending or is dimensionally stable against traction. Furthermore, such a material can be easily combined with other materials to a compound material.

According to a preferred embodiment of this invention, the substructure material can contain one layer or more further layers which can contain in particular an adhesive material, a filling material and/or other auxiliary materials. An adhesive material serves in this context to the connection of adjoining layers, i.e. in particular to the connection of an incompressible layer with a compressible layer. Filling materials are used in order to give a desired volume (→thickness layer) to the substructure material without influencing the material properties as for the rest. Furthermore, layers of other auxiliary materials can be provided which improve for example the connection with the carrying cylinder, with the printing form or the printing plate, with the printer's blanket or the like or which make available certain outer surfaces.

In a special configuration of the substructure material, the substructure material contains at least two compressible layers, whereby these layers can preferably have a different structure with respect to the basis material and/or with respect to the structure (porosity) and/or a different thickness. The behavior of the substructure material can be controlled by the combination of several compressible layers when pressure is introduced, Thus, a good local absorption of pressure and force peaks can be achieved for example by a thicker or a stronger compressible layer in direct contact with the printing form or printing plate, whereas a firmer (thinner) material in a lower position results in that bigger forces which are introduced are distributed over a bigger area.

In a further special configuration of the substructure material, the substructure material contains at least two incompressible layers which again can have a different structure with respect to the basis material and/or to the structure and/or which can have a different thickness. The behaviour of the substructure material can also be purposefully controlled by these measures. Thus, in particular the layers which have a direct contact with the carrier elements can be optimally designed for a connection; this means that these materials have for example a sufficient resistance (to tear) and/or a sufficient thickness for a placement on a cylinder. On the other hand, layers which are inside the substructure material can be minimized to a thickness which is sufficient to be able to fulfil their carrier function inside the whole compound.

The whole (layer) thickness of the plane substructure material can be in the range of approximately 0.5 millimeter to approximately 4 millimeters, in particular it can be from approximately 1.5 millimeter to approximately 2.5 millimeters. For such layer thicknesses, existing printing devices can be equipped later on with the substructure material without or without essential changes in order to assure a compensation of inequalities in the intended manner.

A printing device is also the subject of this invention, in particular an offset printing device for printing materials to be printed, preferably made of paper or of cardboard, with a particularly uneven surface, comprising
a form cylinder on which a printing form, in particular a flatbed printing form, or a printing plate, in particular a flatbed printing plate, is tentered;
a printer's blanket cylinder on which a printer's blanket, which is substantially dimensionally stable in its extension plane, in particular a rubber blanket, specially a compressible or an incompressible rubber blanket, is tentered and
a counter-pressure cylinder.

This printing device is characterized in that the form cylinder and/or the printer's blanket cylinder and/or the counter-pressure cylinder and/or other surfaces participating in the printing are coated on their surface with the above described substructure material. By reason of the explained properties of the substructure material, a printing result of higher quality can be achieved with such a printing device. Furthermore, when the substructure material is fixed on the form cylinder which carries the printing form or the printing plate, a later equipment of this form cylinder with different printing forms or printing plates can be realized in a simpler, less complicated way.

A printer's blanket with the characteristics of claim 15 brings the following advantages. An increased deformation of the special printer's blanket radially to the printer's blanket cylinder during the printing process is made possible in particular by a flexible underlay layer on the lower side or inside the special printer's blanket. The deformation is possible with a force which is lower that that of the deformation of a known compressible printer's blanket. Simultaneously, the longitudinal stability of the special printer's blanket is maintained, whereby a good printing quality is guaranteed. Thus, the printing on an uneven surface of any material to be printed such as, for example, corrugated cardboard, is possible in the offset printing technique. There result many further process advantages which come from the offset printing process. In particular, these advantages are the use of cheap printing forms and a simpler registering for the multicolour printing.

### SHORT DESCRIPTION OF THE DRAWINGS

Two embodiments of this invention will be explained in detail below with reference to the drawings.

FIG. 1 shows a first embodiment of an offset printing device according to this invention in a schematic representation.

FIG. 2 shows a first embodiment of a typical layer structure of the substructure material according to this invention in a schematic sectional representation.

FIG. 3 shows a second embodiment of an offset printing device according to this invention in a schematic representation.

FIG. 4 shows a printing action in a printing area of the offset printing device of FIG. 3 in a schematic sectional representation.

FIG. 5 shows the printing area of FIG. 4 in a schematic sectional representation.

### DETAILED DESCRIPTION OF THE INVENTION AND BEST WAY FOR CARRYING OUT THE INVENTION

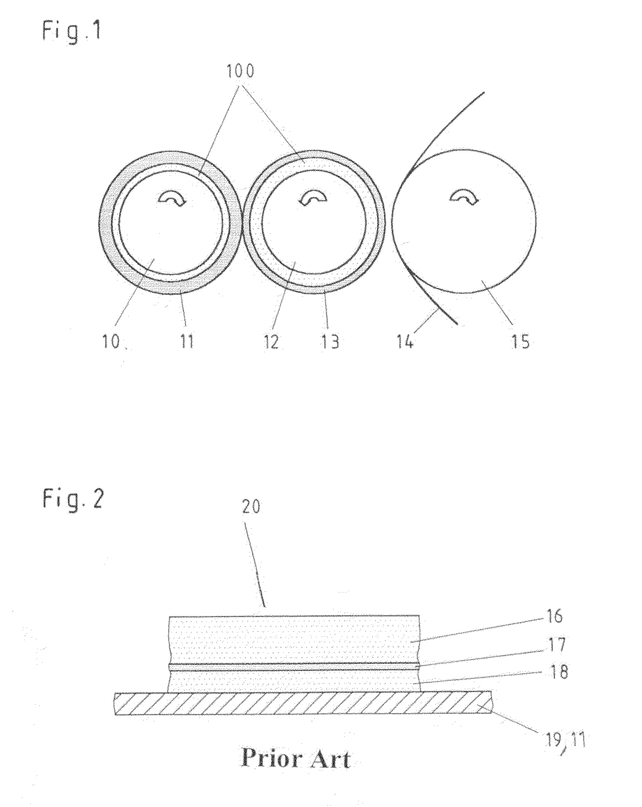

The same or similar configurations, elements or characteristics are indicated with identical reference numerals in the FIGS. 1 to 5.

The essential elements of an offset printing machine for a rotary printing are represented in FIG. 1. The printer's copy is in form of a so-called printing form or printing plate 11 on a first rotating cylinder, the form cylinder 10; this form cylinder 10 is sometimes also designated as a plate cylinder. The surface of the printing plate 11 consists according to the contour to be printed of hydrophilous (Le. water friendly) or lipophil (i.e. grease friendly) areas so that the lipophil printing colour applied by an inking system (which is not shown in FIG. 1 for reasons of clarity of the representation) adheres only to the corresponding lipophil areas. By using water emulsion colours, the adhesive conditions are inverted so that the areas to be printed on the printing plate 11 have to be lipophob, i.e. have to be coated grease resistant.

The form cylinder 10 is in contact with a rubber blanket cylinder 12. The surface of this rubber blanket cylinder 12 is covered by a rubber blanket 13. For an opposed rotation of the two cylinders 10 and 12, the colour which is on the printing plate 11 is transferred to the rubber blanket 13. With the further rotation of the rubber blanket cylinder 12, this colour is then deposited on the paper web to be printed 1A. The paper web 14 is guided by a counter-pressure cylinder 15 (sometimes also designated as a form cylinder) which assures a corresponding pressure against the rubber blanket 13.

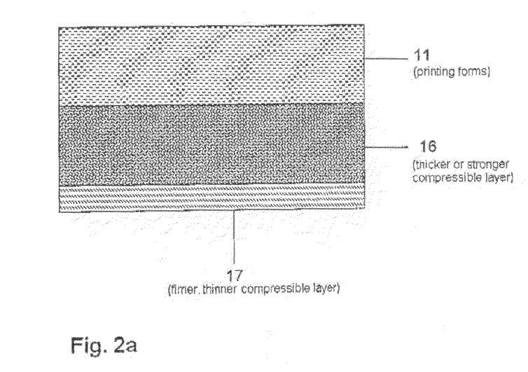

The offset printing method exemplified by means of the FIGS. 1 and 2 (→first embodiment) is improved by the fact that a substructure material 100 is applied between the form cylinder 10 and the printing plate 11 and/or between the rubber blanket cylinder 12 and the rubber blanket 13 and/or on the counterpressure cylinder 15, this material being formed by a compound made of a compressible layer and of an incompressible layer.

The mounting of such a substructure material 100 on the form cylinder 10 and on the rubber blanket cylinder 12 is represented in FIG. 1. Inequalities or unbalanced masses of the form cylinder 10 and/or of the printing plate 11 can be mended and compensated by the substructure material 100; the image to be printed is thus improved. Furthermore, the mounting of the printing plates 11 on the form cylinder 10 is facilitated and thus the further equipment of the printing plates 11 optimized. In this context, the substructure material 100 allows high printing rates.

A typical layer structure of the substructure material 100 is represented in FIG. 2. The substructure material 100 placed on a carrier 19 shows, in the case represented in FIG. 2, three different layers 16, 17 and 18 in a sandwich structure.

The lowest layer, i.e. that in contact with the carrier 19, is a open-cell polyurethane cushion 18 with a thickness of approximately 0.51 millimeter. In the middle, there is a mylar film 17 which is a hard not compressible synthetic material. The sandwich structure is terminated by an open-cell polyurethane cushion 16 with a thickness of approximately 1.02 millimeter. The whole thickness of the substructure material 100 is approximately 2.10 millimeters.

The different layers 16, 17 and 18 can be connected with each other by adhesive layers. The plastic plate or plastic foil 17 assures a sufficient firmness of the substructure material 100. Due to the compressible layers 16 and 18 placed on both outer faces of the sandwich material, inequalities of the cylinder 19 as well as of a laying-on device, such as for example a printing plate 11, can be compensated. The upper side 20 of the polyurethane cushion 16 is configured preferably smooth (and without adhesive) in order to be appropriate in particular for the laying-on layer of a rubber blanket 13.

Thus, with the substructure material 100 according to the first embodiment of the FIGS. 1 and 2, firm, compressible substructures can be formed for printing plates for the offset printing as well as for the hybrid printing with flexographic printing units and with offset printing groups. The sandwich structure of the substructures is then formed by compressible foam cushions with different embossings as well as by plastic plates or plastic foils. One or several, in particular different polyurethane cushions with one or with several, in particular with different plastic plates or plastic foils can be combined with each other: the thickness of the polyurethane cushions and/or plastic plates or plastic foils combined in a sandwich can also vary.

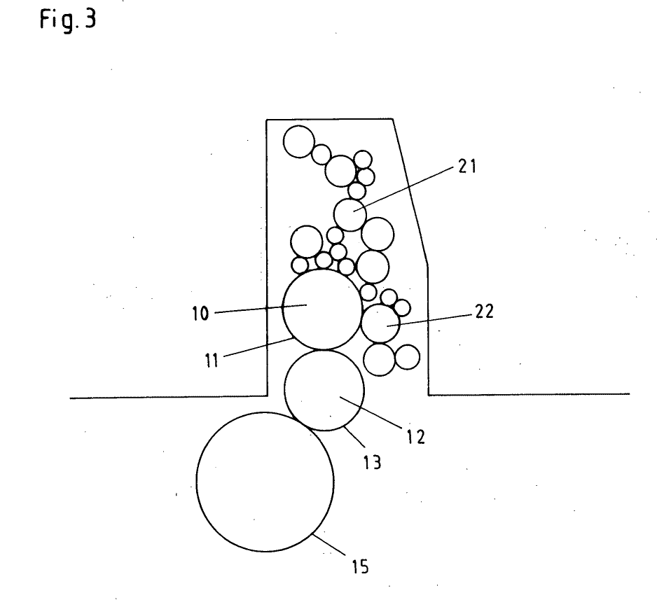

A second embodiment of an offset printing group according to this invention is represented schematically in FIG. 3. The offset printing group shows a counter-pressure cylinder 15, a printer's blanket cylinder 12, a form cylinder 10 and, assigned to the form cylinder in, a printing colour unit 21 and a dampening unit 22.

The counter-pressure cylinder 15 serves to the guiding of a web of a material to be printed. For this, the counter-pressure cylinder 15 is provided with a claw-feed system (which is not shown in detail in FIG. 3 for more clarity). The web of material to be printed is guided on a smooth surface.

The printer's blanket cylinder 12 is placed opposite the counterpressure cylinder 15. The printer's blanket cylinder 12 is tentered with a printer's blanket 13 which is longitudinally stable and flexible in the direction transversely to its surface extension and which can be compressible to a slight extent. The printer's blanket 13 is firmly clamped on the printer's blanket cylinder 12.

The form cylinder 10 is assigned to the printer's blanket cylinder 12. A printing plate or a printing form 11, which usually consists of a thin metal plate in the offset printing, is tentered on the form cylinder 10. The printing form 11 is fed with printing colour by the printing colour unit 21, whereby the printing surfaces beforehand became different from the non printing surfaces by means of water feed by the dampening unit 22. In such an offset printing group, as represented as an example in FIG. 3, it is provided for to make possible the transfer of printing colour onto the materials to be printed with a varying thickness, whereby the printing quality should be as uniform as possible over the whole surface.

In FIG. 4, a printing area according to FIG. 3 is represented for this between the printer's blanket cylinder 12 and the counterpressure cylinder 15, whereby the outlined diameter ratios between the counter-pressure cylinder 15 outlined in FIGS. 3 and 4 below and the printer's blanket cylinder 12 outlined in FIGS. 3 and 4 above do not have to correspond to reality.

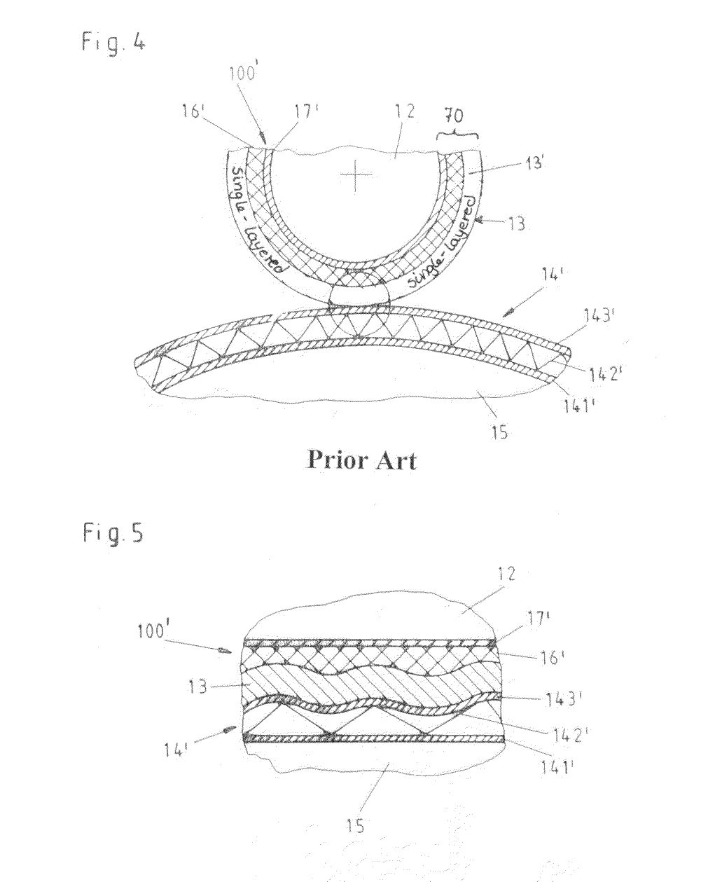

A material to be printed is represented on the counter-pressure cylinder 15 in FIG. 4, this material being configured in this second embodiment as corrugated cardboard 14′. The corrugated cardboard 14′ shows a lower covering layer 141′ outlined in FIGS. 4 and 5 below as well as an upper covering layer 143′ outlined in FIGS. 4 and 5 above; both covering layers 141′, 143′ are connected with each other by a corrugated connecting layer 142′, whereby the lower covering layer 141′ is glued on the lower edges of the connecting layer 142′ and the upper covering layer 143′ is glued on the upper edges of the connecting layer 142′; due to this connection, a very stable material to be printed, which is often used in particular for packing material, is formed.

The printer's blanket cylinder 12 is placed again opposite the counter-pressure cylinder 14, a printer's blanket 13 being indicated on the outside of this printer's blanket cylinder. The printer's blanket 13 is drawn as a homogeneous layer in FIG. 4, whereby normally printer's blankets are configured as so-called rubber blankets and are composed of a non tensile basis layer and of a flexible covering layer. Further intermediate layers which improve the functionality of the printer's blanket can come to this.

Furthermore, a substructure material 100′ configured as a printer's blanket underlay is placed on the printer's blanket cylinder 12 under the printer's blanket 13 directly on the surface of the printer's blanket cylinder 12. This substructure material 100′ is composed of a non tensile basis layer 17′ and of a flexible covering layer 16′ placed on the basis layer 17′. While the non tensile basis layer 17′ can be a solid plastic foil, the flexible covering layer 16′ is preferably a layer made of foam with certain qualifications.

Due to the non tensile basis layer 17′, the substructure material 100′ configured as a printer's blanket underlay can be tentered together with the printer's blanket 13 onto the printer's blanket cylinder 12, whereby the foam (→flexible covering layer 16′) is firmly connected with the, plastic foil (→non tensile basis layer 17′). Consequently, the surface of the printer's blanket cylinder 12 is similar to a conventional printer's blanket cylinder.

In FIG. 5, a cutout of FIG. 4 is represented in detail. The corrugated cardboard 14′ can again be recognized on the lower side. The printer's blanket 13 which has adapted itself to the deformed surface of the corrugated cardboard 14′ is placed above the corrugated cardboard 14′. The height differences with respect to the surface of the printer's blanket cylinder 12, which is partially represented on the lower side, are compensated by the flexible covering layer 16′, designed as a foam layer, of the substructure material 100′ configured asa printer's blanket underlay. The foam material is compressed at the points on which the surface of the corrugated cardboard 14′ is solid, whereby the printer's blanket 13 can yield while it deforms correspondingly by bending.

The printer's blanket 13 can follow the deformable surface of the corrugated cardboard 14′ in the intermediate spaces between two solid fins of the corrugated cardboard 14′, whereby the flexible covering layer 16′ takes up this compensating function due to the configuration as a foam layer.

Due to the corresponding adjustment of the printing assignment, i.e. to the determination of the functional distance of the printer's blanket cylinder 12 and the counter-pressure cylinder 15 or due to the selection of different foam layers for the, substructure material 100′ configured as a printer's blanket underlay, the existing printing device can be used for the most different qualities of materials to be printed with uneven surfaces. For relatively easyly compressible materials to be printed, such as the corrugated cardboard 14′ shown in the second embodiment of the FIGS. 3 to 5, a softer foam material as for relatively hard materials to be printed, such as embossed solid board, is necessary.

For a good function and for the necessary printing quality, the thickness of the substructure material 100′ configured as printer's blanket underlay is important. Fundamentally, substructure materials 100′ with a thickness of approximately 0.5 millimeter to approximately 3.00 or 4.00 millimeters are taken into account for the use mentioned. For the application technique of known materials to be printed, the selection of substructure materials 100′ with a thickness of approximately 1.00 millimeter to approximately 2.00 millimeters is to be preferred. As a foam material, a foam material which is reversibly compressible over many active cycles is to be preferred/. Here, an open-cell foam material is preferably used. This foam material is more easily compressible than the known closed-cell layers in printers blankets.

The special printer's blanket 13, 70 can be produced from a conventional printer's blanket preferably in that the basis layer 17′ is also embedded into the printer's blanket. The mentioned open-cell foam material is preferably put in onto an existing non tensile textile layer or onto a differently configured basis or carrier layer of the printer's blanket. The active layer 13′ can be applied on the foam. Thus, we obtain the advantage that, for a resistance to tension remaining constant of the special printer's blanket 70 with respect to a conventional printer's blanket, a considerably improved flexibility in the direction transversely to the surface extension of the special printer's blanket 70 is obtained, especially in its active layer 13′ (FIG. 4).

A simple improvement of the action of the special printer's blanket 70 can be obtained in that only one part of a conventional printer's blanket is laminated onto the substructure material 100′ or onto the lower layer. Moreover, a part of the most textile lower layers which realize the resistance to tension of the printer's blanket can be cut off of a conventional printer's blanket. Thus, the dimensional stability of the printer's blanket in the active area is still sufficiently assured. A printer's blanket weakened in its rigidity transversely to the active plane can now be applied as an active layer 13′ onto the substructure material 100′ or onto the covering layer 16′ of the lower layer. Thus, a special printer's blanket 70 of the type described above can be produced in a simple way and can be tentered on a printer's blanket cylinder 12 in a just as simple way.

Furthermore, in the area of the clamping edges of the special printer's blanket 70, a reinforcement can be provided for in the art that the clamping as well as the use of the special printer's blanket 70 during the printing operation can be improved. Here, the special printer's blanket 70 is flattened at its ends to a thickness appropriate for the clamping devices existing in a printer's blanket cylinder 12 after the assembly of the active layer 13′ and of the lower layer. The clamping ends produced in this way can furthermore be provided with a reinforcement in form of a metal rail or of other appropriate reinforcements in order to avoid that substances of the printing process penetrating into the covering layer 16′ or into the foam material influence negatively the elasticity of the covering layer, the front edges of the clamping ends of the special printer's blanket 70 can be provided with a coating. In this way, a special printer's blanket 70 is represented which contains a voluminous active area made of a flexible active layer 13′ with an appropriately compressible lower layer. But moreover, the special printer's blanket 70 can be tentered on a printer's blanket cylinder 12 like a conventional printer's blanket of known thickness.

The structure of the described voluminous special printer's blanket 70 can be varied in wide areas, whereby the original materials (conventional or other printer's blanket, lower layer or built-in layer of open-cell foam) and their structure constitute the general conditions. The connection between the active layer 13′ and the non tensile basis layer 17′ or the embedding of the foam material into a printer's blanket between the active layer 13′ and an additional eventually conventional carrying layer for producing the special printer's blanket 70 is carried out with known conventional means.

1-29. (canceled)

30. A substructure material for a printing form, a printing plate, a printing blanket, or another surface taking part in a printing process during printing, wherein the substructure material is a replaceable composite that is elastically deformable radially to a cylinder or radially to a drum, wherein the composite is an underlay which can be stretched, the composite is comprised of at least two compressible layers and at least one incompressible basis layer, the compressible layer is a reversibly compressible functional layer and is made of a microcellular material, the compressible layer has a thickness of approximately 0.5 millimeters to approximately 3millimeters, wherein the composite further comprises at least one layer made of a material selected form the group consisting of adhesive material, filling material and auxiliary material, the compressible layers comprising a first compressible layer in direct contact with the printing form or printing plate, and a second compressible layer remote from the printing form or printing plate wherein the first compressible layer is thicker or stronger than the second compressible layer.

31. The substructure material according to claim 30, wherein the compressible layer has a thickness of approximately 1.2 millimeters to approximately 1.6 millimeters.

32. The substructure material according to claim 30, wherein the microcellular material has open pores.

33. The substructure material according to claim 32, wherein the microcellular material is a foam.

34. The substructure material according to claim 32, wherein the microcellular material is polyurethane foam.

35. The substructure material according to claim 30, wherein the underlay is selected from the group consisting of a printing form underlay, a printing plate underlay and a printing blanket underlay.

36. The substructure material according to claim 30, wherein the cylinder is associated with at least one member selected from the group consisting of a printing form, a printing plate, a printing blanket and any other surface participating in the printing process.

37. The substructure material according to claim 30, wherein the printing process is offset printing.

38. The substructure material according to claim 30, wherein the printing form is a flatbed printing form.

39. The substructure material according to claim 30, wherein the printing plate is a flatbed printing plate.

40. The substructure material according to claim 30, wherein the printing blanket is a rubber blanket.

41. The substructure material according to claim 40, wherein the rubber blanket is compressible or incompressible.

42. (canceled)

43. (canceled)

44. The substructure material according to claim 30, wherein the incompressible layer is a dimensionally stable plate or foil.

45. The substructure material according to claim 30, wherein the incompressible layer contains at least one synthetic material.

46. The substructure material according to claim 45, wherein the incompressible layer contains polyester.

47. (canceled)

48. (canceled)

49. (canceled)

50. The substructure material according to claim 30, having a thickness in a range of approximately 1.5 millimeters to approximately 2.5 millimeters.
